(19) United States
(12) Patent Application Publication
(10) Pub. No.: US 2005/0049726 A1
(43) Pub. Date: Mar. 3, 2005

(54) Input device for building automation

(76) Inventors: Hugh P. Adamson, Boulder, CO (US); Scott Hesse, Longmont, CO (US)

Correspondence Address: MARK D. TRENNER, 12081 WEST ALAMEDA PARKWAY #163, LAKEWOOD, CO, 80228, US

(21) Appl. No.: 10/929,077

(22) Filed: Aug. 27, 2004

Related U.S. Application Data
(60) Provisional application No. 60/499,230, filed on Aug. 29, 2003.

(51) Int. Cl. G05B 11/01

(52) U.S. Cl. 700/19; 703/1; 700/275

(57) ABSTRACT

Implementations of an input device for building automation systems are described and claimed herein. An exemplary implementation of an input device includes an input sensing circuit and a processor operatively associated with computer readable storage. Computer readable program code is stored on the computer readable storage and executable by the processor to receive input signals identifying input received by the input sensing circuit and categorize the input into data gathering input and event input.

### PRIORITY APPLICATION

This application claims priority to co-owned U.S. Provisional Patent Application Ser. No. 60/499,230 for “Input Device for Building Automation” of Adamson, et al. (Attorney Docket No. CVN.011.PRV), filed Aug. 29, 2003, hereby incorporated herein for all that it discloses.

### TECHNICAL FIELD

The described subject matter relates to building automation, and more particularly to input devices for building automation systems.

### BACKGROUND

The ability to automatically control one or more functions in a building (e.g., lighting, heating, air conditioning, security systems) is known as building automation. Building automation systems may be used, for example, to automatically operate various lighting schemes in a house. Of course building automation systems may be used to control any of a wide variety of other functions, more or less elaborate than controlling lighting schemes.

Building automation systems may include devices which respond to changes in the building environment or predetermined events. For example, a thermostat may activate the climate control system in response to the temperature in the building rising or falling. As another example, lighting may be turned on or off according to a timer. These devices are typically provided with a dedicated sensor and the device is limited to specific functions based on input from the dedicated sensor. If the sensor fails the device may become unusable.

More sophisticated building automation systems may use computer controls. These computer controls may be daunting to the user and therefore the user fails to realize the full potential of the building automation system. If these computer controls fail, the user may be unable to use all or part of the building automation system. An electrician typically needs to make a house call, shut power to the entire building automation system, and replace the device.

### SUMMARY

Implementations of an input device for building automation systems are described herein. In an exemplary implementation, an input device is provided including an input sensing circuit and a processor operatively associated with computer readable storage. Computer readable program code is stored on the computer readable storage and executable by the processor to receive input signals identifying input received by the input sensing circuit and categorize the input into data gathering input and event input.

In another exemplary implementation, a method to respond to events in a building automation system is provided. The method may include: categorizing input signals into data gathering input and event input, generating data signals identifying the data gathering input, issuing the data signals to a data collection repository in the building automation system for data analysis, generating event signals for the event input, and issuing the response signals to at least one automation device in the building automation system for responding to an event.

### BRIEF DESCRIPTION OF THE DRAWINGS

FIG. 1 is an illustration of an exemplary building automation system in which input devices may be implemented.

FIG. 2 illustrates functional components of an exemplary input device

FIG. 3 is an exemplary implementation of an input sensing circuit.

FIG. 4 is an exemplary implementation of a device status circuit.

FIG. 5 illustrates operations to process events at an input device.

### DETAILED DESCRIPTION

Exemplary input device described herein may be implemented to process one or more events from a variety of different types of sensors in a building automation system. The input device may notify one or more automation devices of the event. In yet other implementations, input device may also be used for data gathering.

Automation devices may be programmed to respond to events based on input received at the input device. The automation devices may also be reprogrammed independent of the input device to respond differently to events without having to reprogram the input device.

In addition, the input device circuitry operates on low voltage power which may be provided over the data cable. Such an implementation eliminates the need for electrician labor, and allows for fast, simple, and inexpensive installations, e.g., by low-voltage installers. Low voltage operation also reduces electrical noise. The input device may also be “hot-swapped” without having to remove power to the building automation system.

The input device may also include robust self-diagnostics to detect warning signs for failures or potential failures. If a problem is detected, an email can be automatically launched by the building automation system to a technician explaining the problem. Accordingly, issues can be detected and corrected before the building owner ever recognizes that there is a problem.

### Exemplary System

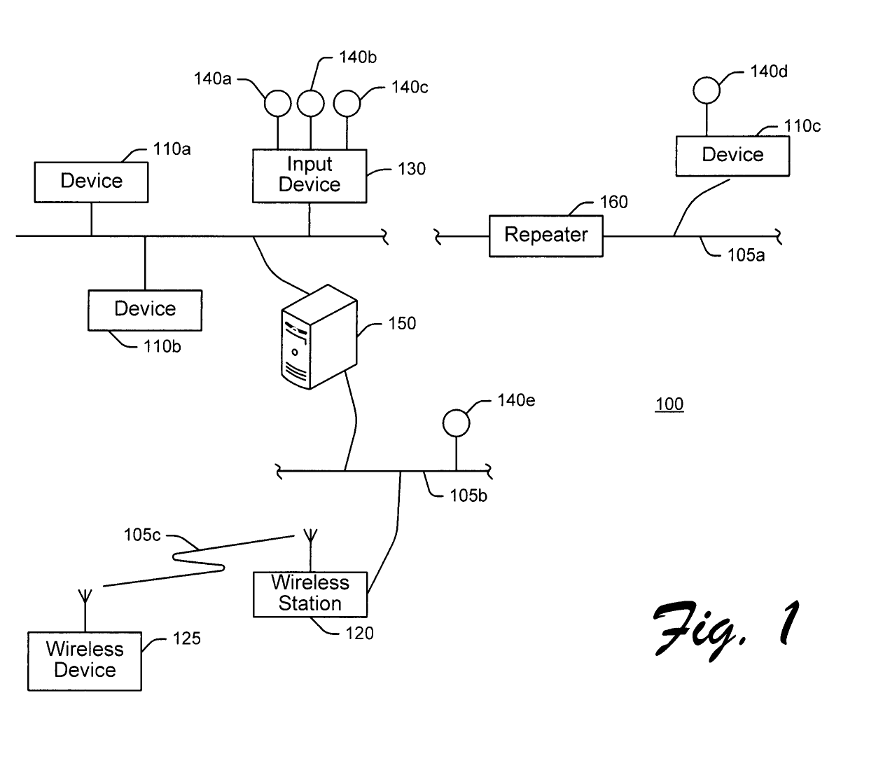

An exemplary building automation system 100 is shown in FIG. 1 as it may be used to automate various functions in a home or other building (e.g., apartment complex, hotel, office building). By way of example, the building automation system 100 may be used to control lighting, heating, air conditioning, audio/visual distribution, operating window coverings to open/close, and security, to name only a few examples.

Building automation system 100 may include one or more automation devices 110a-c (hereinafter generally referred to as automation devices 110). The automation devices 110 may include any of a wide range of types and configurations of devices. Examples include, e.g., security devices, lighting controls, climate controls, keypads, and, to name only a few. Automation devices may also include one or more wireless stations 120 and wireless devices 125.

Building automation system 100 may also include one or more input device 130 (or “i-module”) and one or more sensor device 140a-e. Sensor devices (generally referred to herein by 140) may include, e.g., security sensors, lighting sensors, temperature sensors, and voice recognition devices, to name only a few examples.

Before continuing it is noted that the devices 110 (including input device 130) may be coupled to the network and/or to other devices by hardwiring and/or remote link (e.g., an IR or RF connection).

In an exemplary implementation, input device 130 is configured to receive input signals representing an event in the building automation system 100. For example, the input signal may be issued by a light sensor and may indicate the current lighting level in a room. As another example, the input signal may be issued by a card reader and may identify a person entering the room. The input device 130 processes the input signal and issues an event signal on the network.

Input device 130 may issue the event signal to one or more automation devices 110 in the building automation system 100 causing or instructing the automation device 110 to perform a function corresponding to the event. By way of example, when a light sensor issues an input signals indicating that the overall illumination level in a room has dimmed (e.g., it has become cloudy or it is evening) the input device 130 may issue an event signal corresponding to a central lighting control device. The central lighting control device may in turn increase the lighting intensity in the room to maintain the overall illumination level in the room at a predetermined level.

Automation devices 110, input devices 130 and sensor devices 140 may be communicatively coupled to one another via wired networks 105a-b and/or wireless networks 105c (e.g., an IR connection). In an exemplary implementation, automation devices 110 are coupled to one or more controller area network (CAN) busses. Use of automation devices 110 are described in more detail in co-owned U.S. patent application Ser. No. 10/382,979, entitled “Building Automation and Method” of Hesse, et al. filed on Mar. 5, 2003.

Briefly, the CAN bus may be implemented using a two-wire differential serial data bus. The CAN bus is capable of high-speed data transmission (about 1 Megabits per second (Mbits/s)) over a distance of about 40 meters (m), and can be extended to about 10,000 meters at transmission speeds of about 5 kilobits per second (kbits/s). It is also a robust bus and can be operated in noisy electrical environments while maintaining the integrity of the data.

It is noted, however, that the automation devices 110 are not limited to use with a CAN bus. Indeed, the automation devices 110 may be communicatively coupled to different types of networks. Accordingly, building automation system 100 may also include one or more optional bridges 150 to facilitate communications between different types of networks (e.g., between a CAN bus and an Ethernet).

The term “bridge” as used herein refers to both the hardware and software (the entire computer system) and may be implemented as one or more computing systems, such as a server computer. It is noted therefore that the bridge 150 may also perform various other services for the building automation system 100. For example, bridge 150 may be implemented as a server computer to process commands for automation devices 110, provide Internet and email services, broker security, and optionally provide remote access to the building automation system 100.

Bridge 150 may also be implemented to store a backup copy of program code for the input device 130. If an input device 130 is replaced, the program code may be automatically reloaded to eliminate time-consuming and tedious programming by the installer. The bridge 150 may also download other program code (e.g., scripts or firmware) for operating the input device 130. The input device 130 may also report problems or data collection to the bridge 150 for use by the building automation system.

Building automation network 100 may also include one or more optional repeaters 160, e.g., to extend the physical length of the network, and/or to increase the number of devices that can be provided in the building automation system 100. For example, repeater 160 may be implemented as the physical layer to amplify signals and/or improve the signal to noise ratio of the issued signals in the building automation network 100. Repeater 160 may also be implemented at a higher layer to receive, rebuild, and repeat messages.

It is noted that the building automation system 100 is not limited to any particular type or configuration. The foregoing example is provided in order to better understand one type of building automation network in which the keypad device and methods described herein may be implemented. However, the lighting control systems and methods may also be implemented in other types of building automation systems. The particular configuration may depend in part on design considerations, which can be readily defined and implemented by one having ordinary skill in the art after having become familiar with the teachings of the invention.

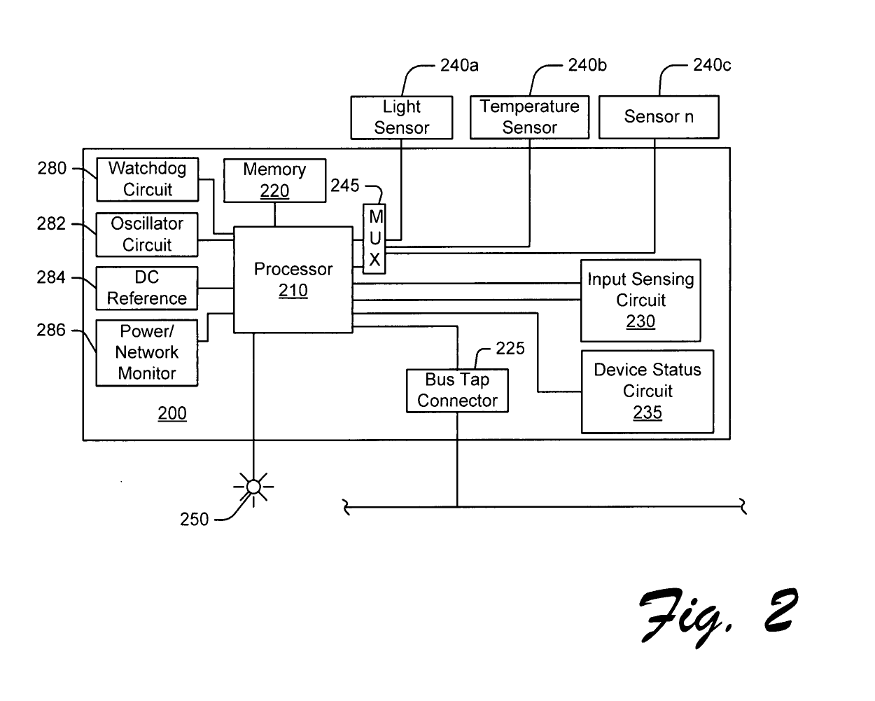

FIG. 2 illustrates exemplary functional components of an input device. Input device 200 may include a processor (or processing units) 210. Processor 210 may be communicatively coupled to a building automation network (e.g., a CAN bus) via a bus tap connector 225, e.g., to send and receive control signals and/or data signals embodied as carrier waves. Processor 210 may also be operatively associated with computer-readable storage 220. Computer-readable storage 220 may include, e.g., non-volatile memory such as FLASH memory and/or battery-backed SRAM.

Processor 210 may also receive input from external sources, such as, e.g., light sensor 220a, temperature sensor 220b. A multiplexer 245 may be provided between the sensor devices 240 and the processor 210 to reduce the number of input signal lines to the processor 210.

Input from the external sources may be used in combination with user-selected functions and/or adjustments using the input buttons. For example, illumination threshold data for a room may be provided by the light sensor 220a to adjust the lighting intensity for a particular user-selected lighting scheme. In another example, the processor 210 may send the illumination threshold data to a light controller to adjust the lighting intensity in the room (e.g., brighter during darkness and dimmer in the daylight).

Other types of sensors and/or data devices (not shown) may also be provided, including but not limited to temperature sensors, clocks, and electronic calendars. Sensor data may also be used by other devices in the building automation system. For example, temperature data may be relayed via the bridge to a climate control device.

Processor 210 may be operatively associated with an input sensing circuit 230 for receiving input from the sensor devices such as, e.g., light sensor 240a, temperature sensor 240b, or any of a wide variety of other input sensor devices (illustrated by sensor 240c). Input sensing circuit 230 signals the processor 210 based on input received from one or more sensor devices 240 (e.g., an open or closed relay).

Processor 210 may be implemented to execute computer-readable program code (stored on computer-readable storage 220) in response to input received from the sensors 240. Processor 210 may execute computer-readable program code for controlling one or more automation devices in the building automation system. In an exemplary implementation, the processor 210 may execute program code for identifying one or more automation devices associated with input received from the sensing devices 240. Processor 210 may also execute computer-readable program code for generating and issuing device commands to automation device(s) based on input at the input device 200.

Alternatively, processor 210 may execute computer-readable program code for generating and issuing an event notification to an automation device. An event notification identifies an event at the input such as, e.g., a key press, a key release, or input received from a sensor or other device in the building automation system. When the event notification is received by an automation device, program code may be executed at the automation device to perform one or more functions corresponding to the event. For example, the automation devices may open/close curtains, execute a lighting scheme, etc. in response to an event at the input.

Computer readable program code may be implemented as scripts. Scripts are computer-readable program code optimized for programmer efficiency (e.g., it is relatively easy to write, flexible, and readily modified). Scripts are preferably independent of the type of processor and/or operating system and are therefore portable to a variety of different environments.

Exemplary implementations of scripts used in building automation systems are described in co-owned U.S. patent application Ser. No. 10/222,525 to Kiwimagi, et al., and entitled “Distributed Control Systems and Methods.” However, it is noted that the computer-readable program code is not limited to scripts, and other implementations of program code (e.g., firmware) now known or later developed may also be used.

Input device 200 may also include robust self-diagnostics to detect warning signs for failures or potential failures. In an exemplary implementation, input device 200 may include an optional watchdog circuit 280, oscillator circuit 282, DC reference circuit 284, and power/network monitor circuit 286 operatively associated with the processor 210. Input device 200 may also include a status indicator (e.g., LED light) to indicate the status of input device to a technician or other user.

Watchdog circuit 280 may be provided to monitor the processor 210 and report problems (e.g., by illuminating an LED light at the input device 200). Watchdog circuit 280 may also include reset capability to reset the processor 210 (e.g., to factory defaults), and/or restart the processor in the event of a failure.

Power/Network monitor 286 may be used to detect problem(s) with automation devices on the network and/or power provided on the network. Input device 200 may report these problems, e.g., to the bridge, which in turn may log the problem or failure and/or notify a system administrator.

Indicators 250 (e.g., an LED light) may also be provided for each of the sensor devices being monitored. Indicators 250 may be used according to one implementation as follows for diagnostic purposes. During normal operation the network monitor 286 may issue an event to an automation device or sensor device on the network. If the input device does not receive a reply signal from the device, an LED light may flash at the input device 200 indicating a potential problem with that device.

Input sensing circuitry 230 may also include test capability. For example, input sensing circuitry may issue a signal that can be used by a technician to determine that the input device is working correctly, without having to physically locate the input device 200 (e.g., behind a wall). For example, where a sensor device should be installed 1000 feet from the installer box, the technician may use a voltmeter at the installer to read a 16 Kilohertz (KHz) signal indicating that the input device is correctly installed on the network. If the signal is more or less than about 16 KHz in this example, the input device is not operating properly (e.g., it was not installed correctly or has failed).

Of course, the invention is not limited to a 16 KHz signal and can be defined by those having ordinary skill in the art after having become familiar with the teachings of the present invention. For example, in another implementation, a sweeping signal (e.g., 14 KHz to 18 KHz) may be varied at 100 times each second allowing a broader spectrum of part tolerances. Such an implementation may increase the reliability of the test signal.

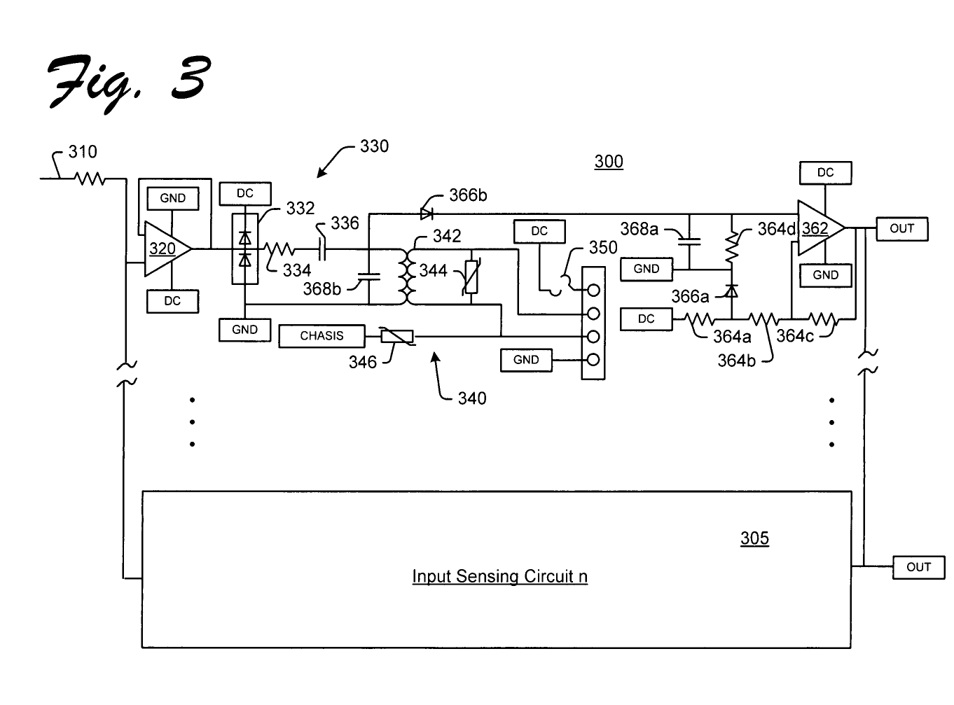

FIG. 3 illustrates an implementation of an exemplary input sensing circuit 300 for an input device. It is noted that a plurality of input sensing circuits, illustrated by block 305, may be provided for the input device to receive input signals from a plurality of sensor devices. Program code (e.g., firmware) provided at the input device may route input signals from sensor devices to the input sensing circuit(s), e.g., at 310. Input sensing circuit 300 generates an output signal (e.g., at 315a, 315b) representative of the input received from the input device for further handling by the processor.

Input sensing circuit 300 can detect an input signal (e.g., about 16 KHz) from a sensor device at least about 2500-3000 feet away from the input module, e.g., coupled to the input module via a twisted pair of wires. Input sensing circuit 300 can also detect either digital or analog signals from sensor devices, allowing the input device determine whether a switch is on/off in addition to data such as, e.g., lighting levels, temperature, etc.

In an exemplary implementation, input is received from sensor device(s) via the processor at 310. Sensing circuit may include an op-amp 320. The input signal passes through op-amp 320 which drives a square wave (e.g., about 14-18 KHz) back and forth (e.g., about 100 Hz) to guarantee an optimum frequency. Input circuitry 330 including, e.g., diodes 332, resistor 334, and capacitor 336, may be provided to clean the input signal and convert it to a sine wave (e.g., having an amplitude of about 0.5 to 1 Volt).

Input sensing circuit 300 may also include a galvanic isolation transformer 340 including, e.g., transformer 342 and metal oxide varistors 344, 346, which makes the input device immune to high voltage (e.g., from a nearby lightning strike or that may otherwise be injected into the system by a burglar trying to compromise the system). That is, the input signal from the sensor devices are magnetically coupled and electrically isolated from the processor at the input device. This implementation makes the input device rugged and practical for field installation (e.g., reducing or eliminating damage from static).

Input sensing circuit 300 may also include a fuse 350 and output circuitry 360. Output circuitry 360 includes, e.g., op-amp 362, resistors 364a-d, diodes 366a-b, and capacitors 368a-b. Output circuitry 360 sets the reference voltage to a low-voltage value that can be handled by the processor. For example, a 3 Volt rectified signal may be converted to a 0.3 Volt output signal. In addition, common mode noise is rejected because it is not differential.

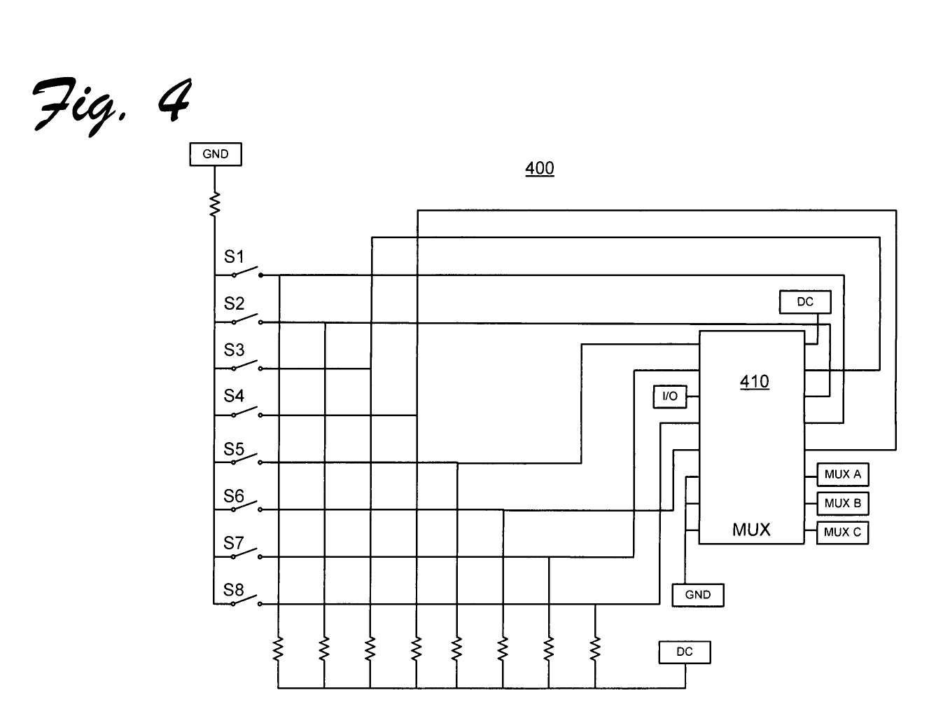

FIG. 4 illustrates an implementation of an exemplary device status circuit 400 for an input device. Device status circuit 400 may include a plurality of switches S1-S8 that can be set to designate whether an input signal received from a sensor device is normally in an open or closed state. Input device may issue signals on the network in response to a change in state of a sensor device (e.g., closed to open or open to closed). These signals can be set to correspond to a “triggered” condition or a “normal” condition through the use of the switches S1-S8 and program code executing at the input device. For example, when the switch is in a normally open position and the input device detects a closed condition at the sensor device, it may send a “triggered” signal to one or more automation devices in the network. When the input device detects a return to the open state, input device may send a “return to normal” signal.

By way of example, a passive IR device may normally be in a closed state. The switch (e.g., S1) corresponding to the IR device may be configured so that the input device responds (generates a data signal or event signal) when input from the passive IR device indicates it is in an open state (i.e., indicating a change). Accordingly, the input device may only issue signals on the network (e.g., to an automation device) when it detects a change of state. A multiplexer 410 may be provided to reduce the number of lines to the processor.

### Exemplary Operations

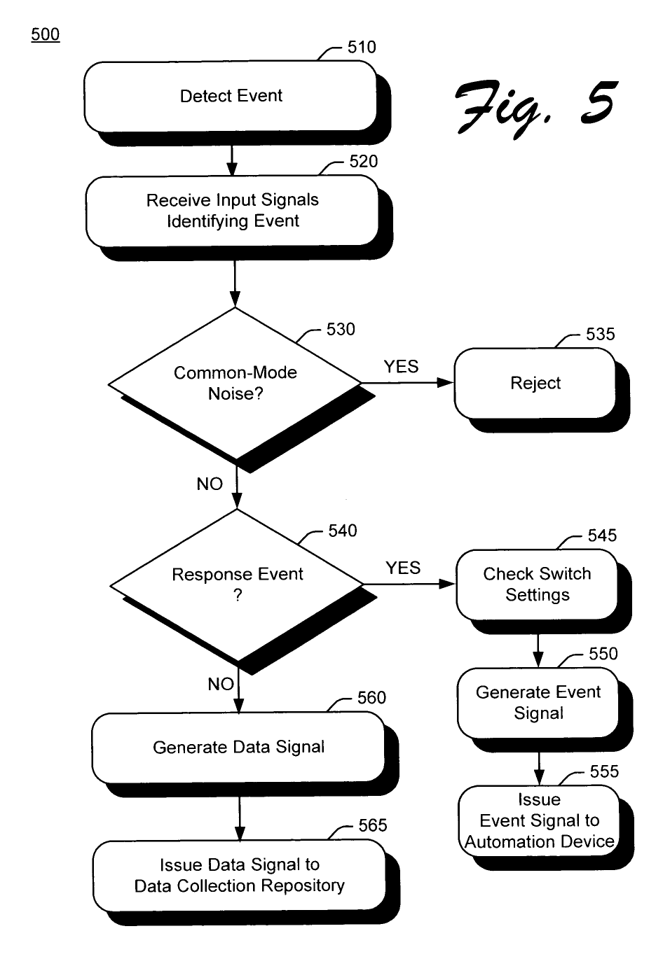

FIG. 5 is a flow chart of operations 500 that may be implemented by an exemplary input device. In an exemplary implementation, the operations may be implemented by computer-readable program code stored in computer-readable storage and executed on a processor (or processing units) at an input device, such as the input device 200 shown in FIG. 2.

In operation 510 an event is detected, e.g., at a sensing device in the building automation system. In operation 520 input signals identifying the event are received at the input device. If common-mode noise is detected in operation 530 it is rejected at operation 535. In operation 540 the input device categorizes whether the input signals are for data gathering (e.g., recording temperature data) or if the input signals indicate an event for response by one or more automation devices (e.g., adjusting the luminescence level in a room due to changing external lighting).

In operation 545 the input device checks the switch settings to determine if the event is in response to a normally open or normally closed state. Accordingly input device determines which event signals to generate (e.g., “normal” or “triggered”). In operation 550 an event signal is generated and issues to one or more automation devices in the building automation system if the input signal is a response event. Alternatively if the input signal is used for data gathering a data signal is generated in operation 560 and issued to a data collection repository in operation 565, e.g., at the bridge for further processing, alerting a monitoring service or other user, logging the data, etc.

It is noted that information detected by one or more sensing devices may be used to generate both data signals and event signals. It is also noted that input may be received from more than one sensor and used to generate data signals and/or event signals.

For purposes of illustration, an input device may be operated as follows to handle an event wherein a multimedia cabinet door is opened/closed. In this example, the input device is operatively associated with a door sensor (e.g., an infrared relay). When a user opens the cabinet door the infrared relay opens (or closes) a signal is received from the IR relay at the input device and the event is detected. The input device in turn issues an event signal on the network identifying the event (i.e., the cabinet door opening) to one or more automation devices on the network.

The signal may be broadcast (e.g., to all devices on the network) or addressed (e.g., to specific devices on the network). The automation devices respond to the signal by executing a command corresponding to the signal (or by ignoring the signal where the signal was not intended for that device). For example, an automation device may respond by turning on lighting in the multimedia cabinet when the cabinet door is opened and turning off the lighting when the cabinet door is closed.

In addition to the specific implementations explicitly set forth herein, other aspects and implementations will be apparent to those skilled in the art from consideration of the specification disclosed herein. It is intended that the specification and illustrated implementations be considered as examples only, with a true scope and spirit of the following claims.

1. An input device for a building automation system comprising:
an input sensing circuit;
a processor operatively associated with computer readable storage;
computer readable program code stored on the computer readable storage and executable by the processor to receive input signals identifying input received by the input sensing circuit and categorize the input into data gathering input and event input.

2. The input device of claim 1, wherein the input sensing circuit includes a plurality of channels for receiving input signals.

3. The input device of claim 1, further comprising test circuitry to issue a signal indicating if the input device is functioning properly without having to physically locate the input device.

4. The input device of claim 1, wherein the input sensing circuit includes an oscillator circuit for receiving input signals at a predetermined frequency.

5. The input device of claim 1, wherein the input sensing circuit includes a transformer circuit for common mode noise rejection.

6. The input device of claim 1, wherein the input sensing circuit includes a metal oxide varistor circuit for protection against electrical transients.

7. The input device of claim 1, further comprising a connection to a CAN bus network in the building automation system.

8. The input device of claim 1, further comprising a watchdog circuit operatively associated the processor for self-diagnostics.

9. The input device of claim 1, further comprising a power monitor operatively associated the processor for self-diagnostics.

10. The input device of claim 1, further comprising a bus tap for coupling the processor to a building automation network.

11. The input device of claim 1, further comprising a status indicator.

12. A method for responding to events in a building automation system comprising:
categorizing input signals into data gathering input and event input;
generating data signals identifying the data gathering input;
issuing the data signals to a data collection repository in the building automation system for data analysis;
generating event signals for the event input; and
issuing the response signals to at least one automation device in the building automation system for responding to an event.

13. The method of claim 12 further comprising receiving the input signals from a plurality of sensing devices.

14. The method of claim 12 further comprising receiving the input signals from a plurality of sensing devices on a CAN bus.

15. The method of claim 12 further comprising rejecting common mode noise from the input signals.

16. The method of claim 12 further comprising generating event signals based on a combination of event input.

17. The method of claim 12 further comprising executing scripts at an input device to categorize the input signals and generate the data signals and event signals.

18. An input device for a building automation system comprising:
input means for generating input;
processing means for receiving the input;
processing means for categorizing the input into data gathering input and event input.

19. The input device of claim 18, further comprising processing means for generating event signals in response to receiving event input.

20. The input device of claim 18, further comprising processing means for generating data signals in response to receiving data gathering input.
